(19) United States
(12) Patent Application Publication
(10) Pub. No.: US 2005/0156563 A1
(43) Pub. Date: Jul. 21, 2005

(54) Inductive charger

(75) Inventors: Heng-I Lin, Taipei Hsien (TW); Feng-Ming Chuang, Taipei Hsien (TW); Yu-Lin Wang, Taipei Hsien (TW); Wen-Yi Chu, Taipei Hsien (TW)

Correspondence Address: TROXELL LAW OFFICE PLLC, SUITE 1404, 5205 LEESBURG PIKE, FALLS CHURCH, VA, 22041, US

(73) Assignee: Liung Feng Industrial Co., Ltd.

(21) Appl. No.: 10/750,758

(22) Filed: Jan. 5, 2004

(51) Int. Cl. H02J 7/00

(52) U.S. Cl. 320/108

(57) ABSTRACT

An inductive charger is adapted for a portable electrical devices or information products and connects with a rectifier for charging. The inductive charger includes a hollow carrier, at least a coil surrounding an outer surface of the carrier, fixed magnets and at least a sliding magnet. The carrier has a pair of end portions opposite to each other, and the fixed magnets are respectively located on the end portions of the carrier. N poles and S poles of the fixed magnets are oriented coincident with each other. The sliding magnet is located between the fixed magnets, and N pole and S pole of the sliding magnet is opposing to N poles and S poles of the fixed magnets. When the carrier is driven, the sliding magnet moves back and forth between the fixed magnets due to magnetic repulsion of the sliding magnet, which changes flux of the coil thereby producing induced electromotive force. With quick moving of the sliding magnet, the induced electromotive force speeds up varying of flux, thereby increasing instantaneous flux. Consequently, the induced electromotive force increases and produces induced current of large magnitude. The inductive charger charges a battery quickly without restriction of place and external power and protects environment.

### BACKGROUND OF THE INVENTION

1. Field of the Invention

The present invention relates to a charger, and particularly to a charger which has magnets moving back and forth in a coil thereof to obtain varied magnetic field thereby producing induced current.

2. Related Art

Batteries are usually used to provide power for a variety of personal portable electronic devices. Batteries become more important especially because of high transmission speed and huge memory in wideband network. However, abandoned batteries in nature have various heavy metals, such as mercury, cadmium and lead etc, gradually leaking out to the nature, consequently polluting water and earth and hurting human beings. People appeal to call back batteries, and to effectively deal with poisonous materials in batteries while recycle rare metals, for example, zinc and manganese. At the same time, persons in the art are endeavor to develop all kinds of “environment-protective” or “green” reused batteries, for example, nickel-hydrogen battery, lithium battery and solar battery.

Correspondingly, it is desired to change traditional charging method to reduce replacement of batteries.

### SUMMARY OF THE INVENTION

Accordingly, an object of the present invention is to provide an inductive charger which charges a battery quickly without restriction of external power and place and which protects environment.

An inductive charger of the present invention comprises a hollow carrier with a pair of end portions opposite to each other. Fixed magnets are respectively located on the end portions of the hollow carrier, where N poles and S poles of the fixed magnets are oriented coincident with each other. A sliding magnet is located between the fixed magnets, and N pole and S pole of the sliding magnet is opposing to N poles and S poles of the fixed magnets. When the carrier is driven, the sliding magnet moves back and forth between the fixed magnets and is limited between the end portions of the carrier due to magnetic repulsion of the sliding magnet and the fixed magnets.

A coil surrounds an outer surface of the hollow carrier. Moving of the sliding magnet in the carrier changes flux of the coil thereby producing induced electromotive force. With quick moving of the sliding magnet, the instantaneous flux change is enhanced, thereby increasing induced electromotive force. At the moment, the induced electromotive force increases and produces an induced current of large magnitude.

### BRIEF DESCRIPTION OF THE DRAWINGS

FIG. 1 is a cross-sectional view of an inductive charger of a first embodiment of the present invention.

FIG. 2 is a plane view of the inductive charger of FIG. 1 applied to a torch.

FIG. 3 shows an inductive charger of a second embodiment of the present invention.

FIG. 4 shows an inductive charger of a third embodiment of the present invention.

### DESCRIPTION OF THE PREFERRED EMBODIMENTS

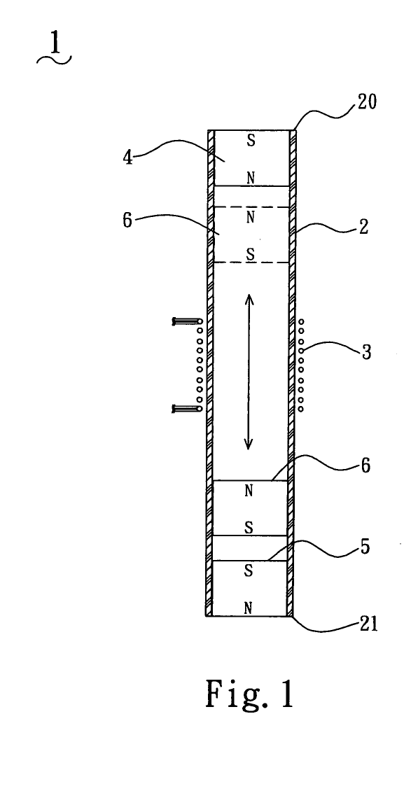

Referring to FIG. 1, an inductive charger 1 of the present invention comprises a hollow carrier 2 with opposite end portions 20, 21, a coil 3, two fixed magnets 4, 5 and a sliding magnet 6. The carrier 2 has an inner surface with the shape of circle, square or other type. The coil 3 surrounds an outer surface of the carrier 2. Where the number of the coils is one or more, which can vary according to required magnitude of the induced current. The coil 3 has two ends for respectively connecting with charging electrical devices. The fixed magnets 4, 5 are respectively located on the end portions 20, 21 of the hollow carrier 2. Magnetic force of the fixed magnets 4, 5 can be also determined according to required magnitude of the induced current. N poles and S poles of the fixed magnets 4, 5 are oriented coincident with each other. The sliding magnet 6 is located between the fixed magnets 4, 5. N pole and S pole of the sliding magnet 6 are oriented reverse to N poles and S poles of the fixed magnets 4, 5. Namely N pole and S pole of the sliding magnet 6 are opposing to N poles and S poles of the fixed magnets 4, 5. In initial state, the sliding magnet 6 remains a certain of distance from the fixed magnets 4, 5. When the carrier 2 is driven, the sliding magnet 6 moves along the dashed line in FIG. 1 due to magnetic repulsion between the sliding magnet 6 and the fixed magnets 4, 5. Moreover, magnetic repulsion between the sliding magnet 6 and the fixed magnets 4, 5 prevents impact of the sliding magnet 6 to the fixed magnets 4, 5. The sliding magnet 6 moves back and forth in the carrier 2, changing flux of the coil 3 thereby producing induced electromotive force. The instantaneous flux change is enhanced with quick moving of the sliding magne, thereby increasing induced electromotive force. At the moment, the induced electromotive force increases and produces an induced current of large magnitude.

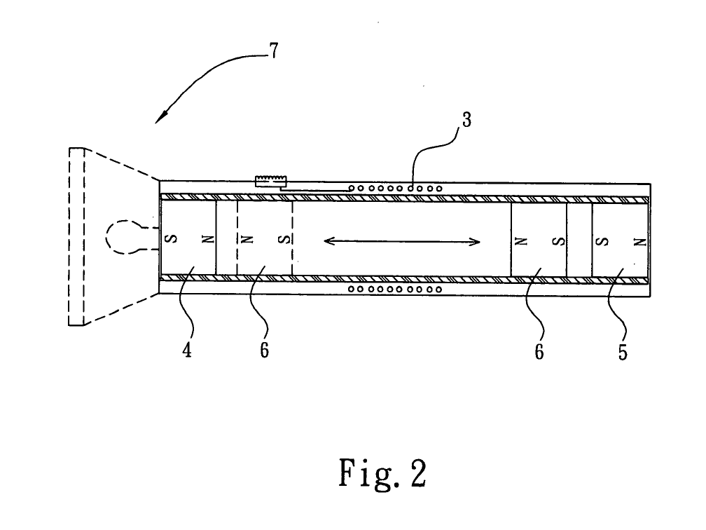

Further referring to FIG. 2, the inductive charger 1 is used for charging a torch 7. Opposite ends of the coil 3 (shown in FIG. 1) respectively connect with positive and negative electrodes of the torch 7. As disclosed above, the torch 7 is driven for charging. The sliding magnet 6 moves back and forth owing to magnetic repulsion of the fixed magnets 4, 5 and increases instantaneous flux change of the coil 3, whereby induced electromotive force increases to produce an induced current.

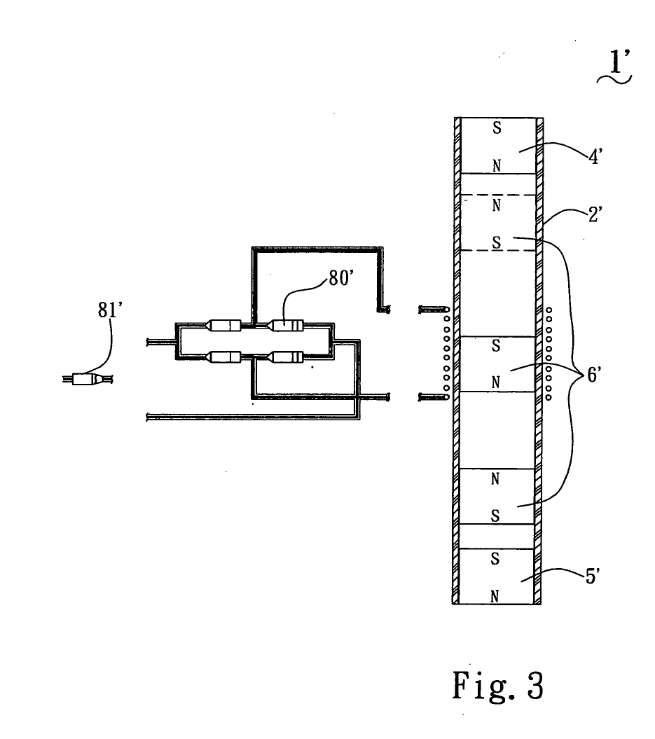

With reference with FIG. 3, an inductive charger 1′ according to a second embodiment of the present invention is designed to enhance overall varying of induced flux. The inductive charger 1′ has two sliding magnets 6′ in a hollow carrier 2′ and a coil 3′ surrounding the carrier 2′. The two sliding magnets 6′ are positioned incident with each other for reducing distance between poles thereof and fixed magnets 4′, 5′. Hence magnetic repulsion is accumulated to increase moving speed of the sliding magnets 6′, thereby enhancing varying of flux of the coil 3′. The coil 3′ has opposite ends connecting with a rectifier 80′ and a plug 81′. The plug 81′ can electrically connect with a charging socket or a socket of charger for charging, correspondingly enlarging application scope of the inductive charger 1′.

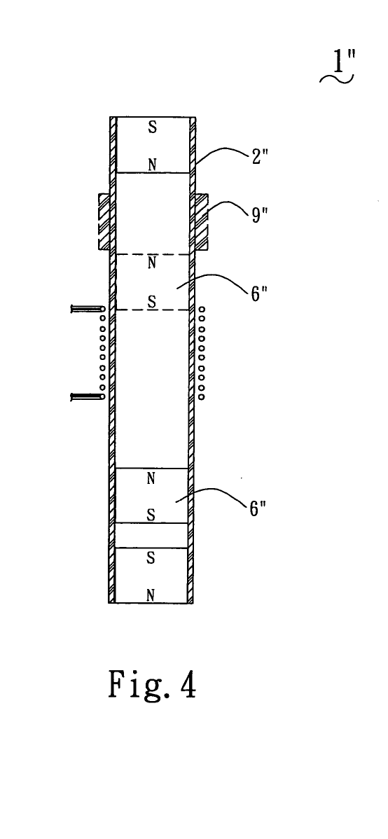

Referring to FIG. 4, an inductive charger 1″ has a magnetizer 3″ surrounding a hollow carrier 2″ for limiting moving distance of a sliding magnet 6″ thereby adjusting magnitude of induced current.

It is understood that the invention may be embodied in other forms without departing from the spirit thereof. Thus, the present examples and embodiments are to be considered in all respects as illustrative and not restrictive, and the invention is not to be limited to the details given herein.

1. An inductive charger adapted for a portable electrical devices and connecting with a rectifier for charging, comprising:
a hollow carrier having opposite end portions and an outer surface, at least a coil surrounding the outer surface thereof;
fixed magnets being respectively located at end portions of the carrier, N poles and S poles of the fixed magnets being positioned coincident with each other; and
at least a sliding magnet between the fixed magnets, N pole and S pole of the at least a sliding magnet being positioned opposing to N poles and S poles of the fixed magnets;
wherein when the carrier moves, the at least a sliding magnet moves back and forth in the carrier due to magnetic repulsion between the at least a sliding magnet and the fixed magnets, flux of the coil varying and producing induced electromotive force, the instantaneous flux change is enhanced with quick moving of the sliding magne, thereby increasing induced electromotive force, correspondingly the induced electromotive force increasing to produce an induced current of large magnitude.

2. The inductive charger as claimed in claim 1, wherein the carrier has an inner surface with the shape of circle, square or other type.

3. The inductive charger as claimed in claim 1, wherein the number of the coils is one or more, which varies according to required magnitude of the induced current.

4. The inductive charger as claimed in claim 1, wherein the number of the at least a sliding magnet is one or more, N poles and S poles of the sliding magnets are positioned coincident with each other for reducing distance between poles thereof and fixed magnets, whereby magnetic repulsion is accumulated and moving speed of the sliding magnets increases.

5. The inductive charger as claimed in claim 1, wherein a magnetizer surrounds the outer surface of the carrier for limiting moving distance of the at least a sliding magnet thereby adjusting magnitude of induced current.

6. The inductive charger as claimed in claim 1, wherein a plug connects with the rectifier to electrically connect with a charging socket or a socket of charger for charging.
